(19) United States
(12) Patent Application Publication
(10) Pub. No.: US 2011/0307796 A1
(43) Pub. Date: Dec. 15, 2011

(54) METHODS, APPARATUS AND SYSTEMS FOR DESIGNING AND EXECUTING AN INITIATIVE

(76) Inventor: Jerome Dale Johnson, Waterville, MN (US)

(21) Appl. No.: 13/217,158

(22) Filed: Aug. 24, 2011

Related U.S. Application Data
(63) Continuation-in-part of application No. 11/683,949, filed on Mar. 8, 2007.
Application No. 11/683,949 is a continuation-in-part of application No. 12/055,299, filed on Mar. 25, 2008, now abandoned.
Application No. 12/055,299 is a continuation-in-part of application No. 12/055,301, filed on Mar. 25, 2008, now abandoned.
Application No. 12/055,301 is a continuation-in-part of application No. 12/206,608, filed on Sep. 8, 2008, now abandoned.
Application No. 12/206,608 is a continuation-in-part of application No. 12/613,515, filed on Nov. 5, 2009.
Application No. 12/613,515 is a continuation-in-part of application No. 12/860,866, filed on Aug. 21, 2010.

(51) Int. Cl. G06F 3/048; G06F 15/16

(52) U.S. Cl. 715/738

(57) ABSTRACT

An initiative may be designed by accessing initiative data stored in one or more databases and using the accessed data to design the initiative. Often times, the initiative may include a link to supplemental information. The initiative may be provided to a user who may select the link. Supplemental initiative information associated with the selected link may then be provided to the user.

### RELATED APPLICATIONS

The present application incorporates by reference in it entirety and is a Continuation in Part (CIP) of U.S. patent application Ser. No. 11/683,949 filed 7 Mar., 2007, U.S. patent application Ser. No. 12/055,299 filed 25 Mar. 2008, U.S. patent application Ser. No. 12/055,301 filed 25 Mar. 2008, U.S. patent application Ser. No. 12/206,608 filed 8 Sep. 2008, U.S. patent application Ser. No. 12/613,515 filed 5 Nov. 2009, and U.S. patent application Ser. No. 12/860,866 filed 20 Aug. 2010.

### FIELD OF THE INVENTION

The present invention relates to methods, graphical user interfaces (GUI), computer-readable media, and systems for designing, communicating and executing an initiative.

### BACKGROUND

Traditionally, mechanisms for generating and communicating sales initiatives (i.e., plans, programs, activities, proposals, deals, actions, measures, strategies, etc., for salespeople with respect to designated products and/or services, often involving some form of remuneration for the salesperson, and sometimes involving specifically designated prospective customers) are limited to direct communication between a wholesaler or manufacturer of a product and/or service and a salesperson. Because salespeople commonly receive such initiative information from a multitude of sources in a variety of formats, there is often no convenient way for the salesperson to organize them. Moreover, initiatives are often communicated with little or no information regarding target customers, relationships to other initiatives, or overall product strategies. As a result, salespeople often have little or no incentive to participate in initiatives and, consequently, the true potentials of many initiatives are never realized.

### SUMMARY

Systems, GUIs, and methods for designing, communicating and executing an initiative are herein described. Generally, such initiatives relate to the selling of a product or a service. That is, the initiatives are programs, strategies, activities, etc., designed to incentivize a salesperson to sell one or more targeted products and/or services to one or more targeted customers (often end-users, but not necessarily so). The customers are often designated individuals or businesses, but need not be designated by name. for example, customers may be designated by a particular profile or attributes (e.g., individuals earning over a certain amount each year, individuals with certain healthcare needs, businesses with certain supply needs, etc.), roles (e.g., director of human resources, director of finance, etc.), responsibilities, purchasing authorities, or other category.

In accordance with an embodiment of the present invention, an initiative is designed by accessing initiative data stored in one or more databases. The initiative data may include some or all of initiative specifications, such as an offer for the sale of a product or service, information concerning financial incentives for a salesperson, relevant expiration dates for the initiative, information regarding financial incentives for prospective buyers of the product(s)/service(s), customer profiles, information regarding other or prior initiatives concerning these or related or other product(s)/service(s), and so on. In some cases, the initiative data may include information stored in one or more databases owned or operated by the salesperson in addition to or even instead of that stored in databases owned/operated by the provider of the relevant product(s)/service(s). On some occasions, the initiative data may include geographical data. Conveniently, such information may be combined with other, relevant information as part of a geographic information system (GIS). This is especially useful in connection with initiatives for agricultural products inasmuch as the use of a GIS can facilitate integration with other knowledge management tools that make us of such a system and/or provide a convenient means for importing information regarding a target customer's land use and related activities.

Regardless of where or how it is stored, once accessed the initiative data is used to design and generate an initiative. Examples of initiatives are provided below, however, for purposes of the present invention there is no specific format which an initiative must satisfy. What does matter is that the initiative is communicated in such a way that it is always readily available to the salesperson in a convenient fashion. Therefore, embodiments of the present invention make use of Web-based dissemination tools which are accessible through any device employing a Web browser or similar communication interface. In one particular example, information regarding initiatives are disseminated through electronic mail (e-mail) messages and/or messages relayed via a messaging system associated with a social networking application to salespeople. The e-mail messages include hyperlinks (which may or may not be personalized to the respective salesperson), which when selected will launch a Web browser at the associated device and automatically log-in a salesperson to a portal through which he/she can review details of the associated initiative. In some instances, this may be referred to as an internet-based solution, a software as a service solution, a cloud-based service, or other term which implies the use of a client-server architecture, where the client is, essentially, a tool equipped with a web browser that is configured to provide an interface for information included at the portal. In addition to the details regarding the initiative, other personalized information may be provided for the sales person via the portal.

For example, the salesperson may be provided a game plan or other strategy for the initiative. Such game plans generally include one or more events designed to facilitate (successful) execution of the initiative. In addition, other information regarding the initiative, its success, and so on may be gathered and provided to the salesperson via the portal.

Importantly, from the standpoint of the salesperson, other information available through the portal includes relationships between two or more initiatives (e.g., either from the standpoint of the salesperson, the customer, or both),. Thus, a salesperson can now determine the most lucrative intiatives to pursue, and their combined effect for the benefit of the salesperson and/or the customer. Such analyses may be provided through an initiative analyzer.

These and other features of the present invention are discussed in detail below.

### BRIEF DESCRIPTION OF THE DRAWINGS

The present application is illustrated by way of example, and not limitation, in the figures of the accompanying drawings, in which:

FIG. 1A is a block diagram illustrating an exemplary system having elements configured to design and execute an initiative in accordance with embodiments of the present invention;

FIG. 1B is a block diagram illustrating exemplary initiative data in accordance with embodiments of the present invention;

FIG. 1C is depicts an exemplary diagram of layered geographic and/or geologic data for an area of land in accordance with embodiments of the present invention;

FIGS. 2A and 2B illustrate exemplary processes for designing and executing an initiative in accordance with embodiments of the present invention; and

FIGS. 3-31 illustrate exemplary GUI for designing and executing an initiative, in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Described herein are methods and system for designing, communicating and executing an initiative. As used in this description and in the claims that follow, an initiative is best regarded as a plan, program, set of one or more activities or actions, proposal, deal, measures, strategies, etc., for a salesperson (or group of salespeople) with respect to designated products and/or services, often involving some form of remuneration for the salesperson, and sometimes involving specifically designated prospective customers. It may also be regarded as a “tool kit” for a salesperson with respect to a particular product and/or service, and/or customer or group of customers, providing the salesperson information regarding the sales process for that product/service/customer. In the examples presented below, particular focus is given to the implementation of the present invention in connection with the sale of agricultural products, however, the invention is not limited to this application and can in fact be deployed, operated an used in connection with virtually any industry or enterprise. Indeed, even governmental organizations may benefit from the present invention in connection with designing, communicating and executing policy programs. Although much of the discussion will assume the salesperson is a human, that need not necessarily be true. Computer-based salespeople (e.g., Web-based stores, etc.) may benefit from the present invention equally as well as their human counterparts. Hence, the term salesperson (or salespeople) is not intended to be limited to humans.

In accordance with embodiments of the present invention, an initiative incorporates data from various sources and provides one or more users, typically salespeople, with information, programs and related materials concerning the selling of a product or service. Among the information will often be information regarding incentives for the salesperson. Conveniently, embodiments of the present invention allow initiatives to be combined so that salespeople can readily understand how the initiatives operate together, how prospective customers may qualify for multiple incentives, and/or how the salespeople can benefit from the combined effect of the various initiatives.

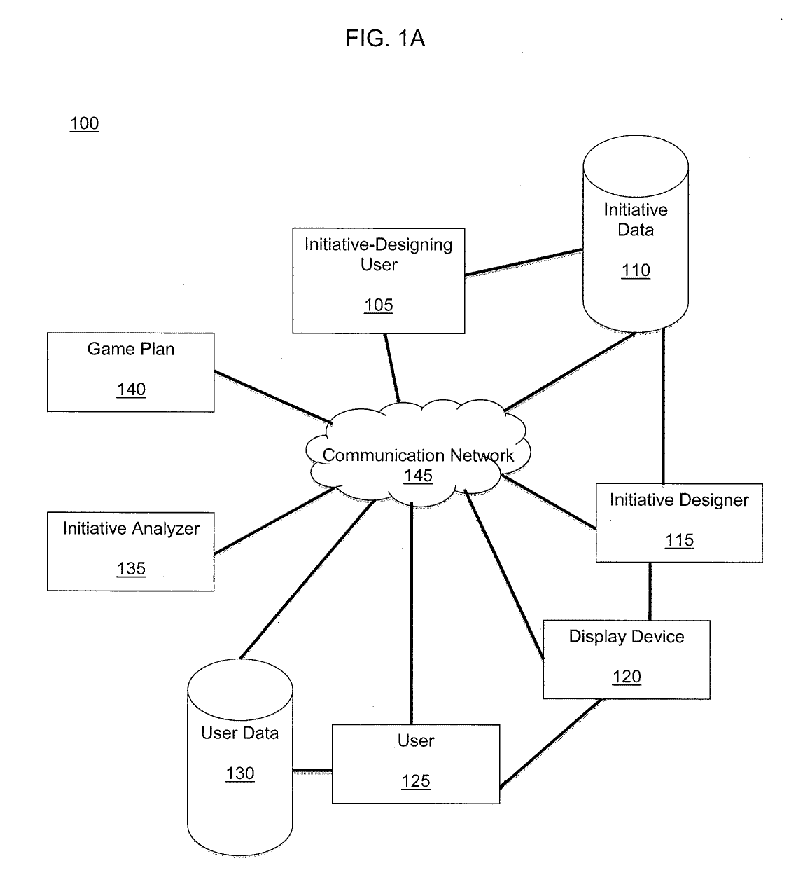

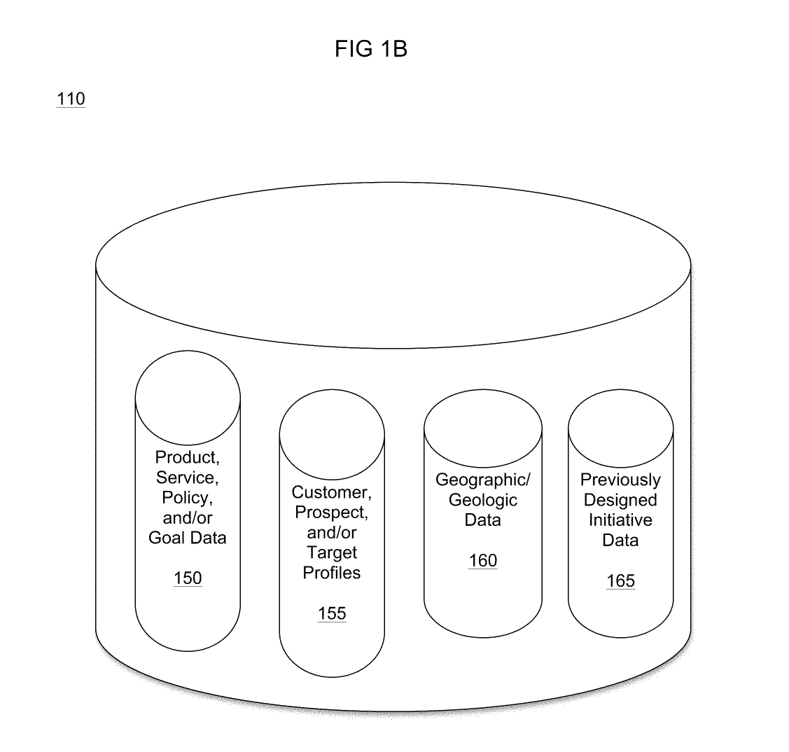

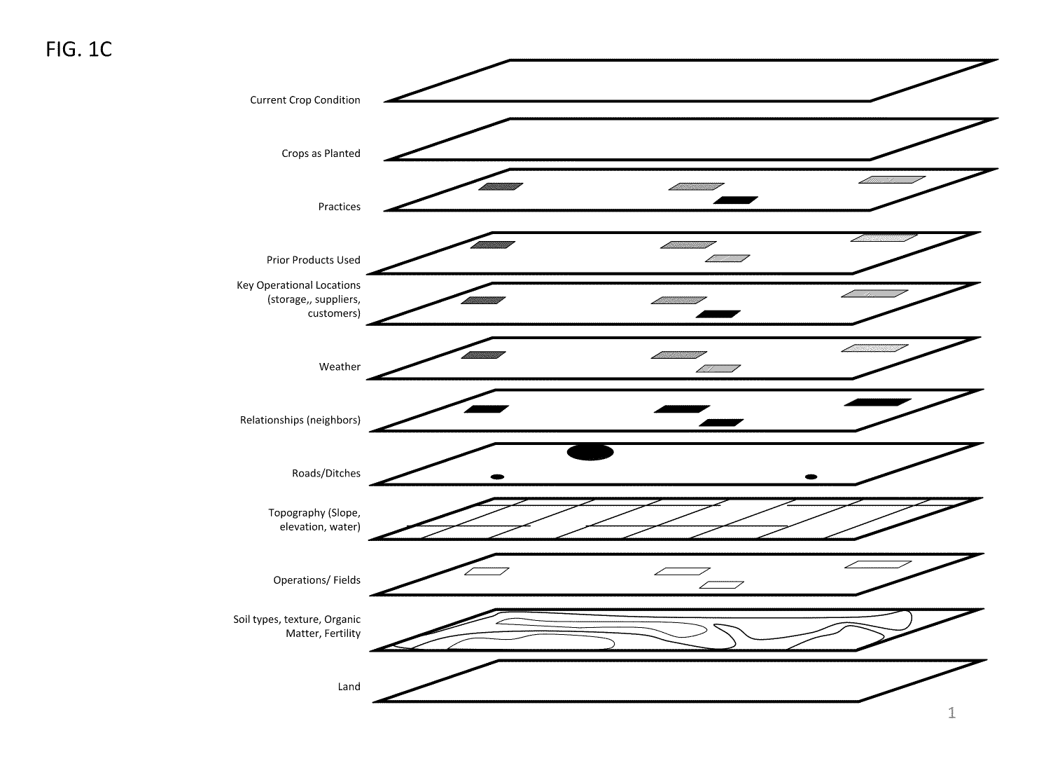

Turning now to FIG. 1A a block diagram depicting an exemplary system 100 for executing one or more of the processes described herein is illustrated. System 100 includes an initiative-designing user 105, an initiative database 110, an initiative designer 115, a display device 120, a user 125, a user database 130, an initiative analyzer 135, a game plan module 140, and a communication network 145. Note, in some instances some of these components may be absent from instantiations of the present invention. For example, once initiatives have been designed and deployed, the initiative-designing user (e.g., a manufacturer or other person or entity in the product/service supply chain) need not be present. Likewise, users (e.g., salespeople) may download initiatives to personal computers, tablet computers or other portable computer-based devices, in which case the initiative information may be self-contained and access to the communications network and other elements of the system not required until the initiative or information concerning sales activities needs to be updated. Thus, system 100 in FIG. 1 is best regarded merely as an example of a system in which the present invention finds application.

As shown, communication network 145 communicatively couples the other elements of system 100 to one another. Exemplary communication networks 145 include cloud computing networks, the Internet, local area networks (LAN), wireless local area networks (WLAN), and wide area networks (WAN). Usually, though not necessarily, the initiative-designing user 105 and the user 125 will connect to the system 100 periodically, either to upload new initiatives, download new initiatives, report sales progress, query databases, and so on. The initiative designer 115, initiative analyzer 135 and game plan module 140, although shown as separate entities in FIG. 1 may and often will reside on a common computer-based platform, such as a server or set of servers. Such a server may be a physical server or a virtual machine executing on another hardware platform. The precise nature of such a configuration is not critical to the present invention.

Initiative designer 115 is configured to design an initiative by receiving input from initiative-designing user 105 and accessing data stored in initiative database 110 and/or user database 130. Exemplary data stored in user database 130 includes customer lists, current and archived proposals, current and archived initiatives, local proprietary customer data, and user accounting records. Exemplary data stored in initiative database 110 includes, but is not limited to, product or service descriptions, initiative specifications, customer profiles, specifications of previously designed initiatives, geographic data, employee lists, member lists for organizations and data regarding an entity associated with the user 125 and/or initiative-designing user 105, such as a policy or goal associated with user 125 and/or initiative-designing user 105. Further details regarding the data provided by initiative data 110 are discussed below with regard to FIG. 1B.

Designing the initiative may be an iterative process. For example, initiative proposals may be rolled out in certain test markets to see how they are received by salespeople and/or customers. Based on feedback from salespeople and others involved in the sales process and of course sales results, the initiatives may be modified in various fashions. Designing an initiative generally involves marrying a product and/or service (or group of products and/or services) with a sales proposal for one or more target customers and including a financial incentive for the salesperson to make a successful sale of the product and/or service (or group of products and/or services) to the target customers. The initiatives may be as simple as sale prices and associated commissions or as complex as special loan and/or rebate incentives for the customer and vesting stock option plans for the salesperson. Most initiatives will involve only one or a few products/services, but some may involve may of either or both. Initiatives may have different tiers of rewards or incentives for the salesperson, or may be cast as “winner take all”, where a top salesperson over a given time span is provided a “prize”. The present invention is not limited to initiatives of one form or other.

Designing an initiative can involve the initiative-designing user manually selecting products, services, financial incentives and other attributes manually. Alternatively, initiatives may be designed in a partially or wholly automated manner by the initiative designer 115 analyzing sales information, consumer trends, salesperson records and the like to develop a set of incentives for both customers and salespeople with respect to certain products and/or services. For example, if the initiative designer identifies products as having been in inventory for longer than a certain period of time, the products may be automatically reduced in price and an initiative designed to inform salespeople about the price drop so that they can advise prospective customers of same. Of course, many other forms of initiatives can be designed.

Once the initiative is designed, initiative designer 115 provides information about the initiative to user 125. This may be done in a variety of ways, including through the use of an e-mail and/or a message relayed via a messaging system or platform associated with a social networking application (e.g., Interaction™, LinkedIn™, Facebook™, or a local social networking application specific to an enterprise associated with the initiative) accessible through communication network 145 that includes hyperlinks to a portal at which details regarding the initiative are available. Other forms of communication, such as an instant message or a text message sent via short message service (SMS) to a salesperson's mobile phone, or an automated phone call placed by the initiative designer, may also be used. In FIG. 1, display device 120 is meant to represent any device via which user 125 can be provided with information regarding the initiative. Exemplary display devices 120 include computer systems, mobile computing devices (including but not limited to so-called “smart phones”), televisions, tablet computing devices, and portable computing devices.

One or more components of system 100 may include a set of instructions stored on tangible and non-transitory computer readable media. The set of instructions may be executed by one or more components of system 100 to perform one or more of the processes described herein. The non-transitory machine-readable storage medium may include a single medium or multiple media (e.g., a centralized or distributed database or data source and/or associated caches and servers) and may include, for example, solid-state memories, optical media, and/or magnetic media.

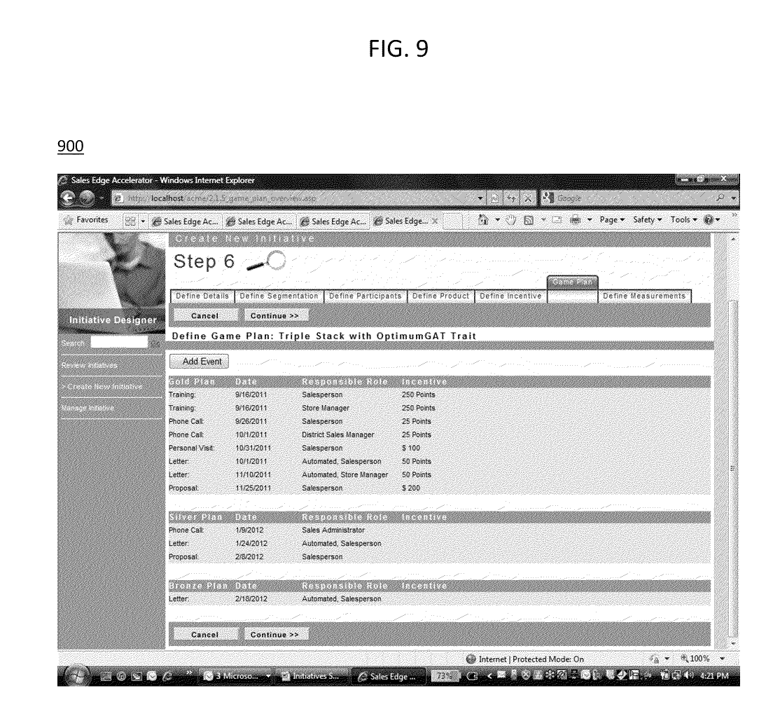

Optionally, system 100 may include game plan module 140 which may design, manage, and/or implement a game plan for an initiative, initiative-designing user 105, and/or user 125. Further details regarding game plans are provided below with respect to FIGS. 9, 24, and 25.

Initiative analyzer 135 is configured to analyze one or more initiatives and provide the results to user 125 and/or initiative-designing user 105. In general and as appropriate, initiative analyzer 135 compares (and combines) multiple initiatives and provides those results to the user. For example, it is often the case that a prospective customer will qualify for more than one initiative (and that the salesperson will benefit from making a combined sale of this nature). But because in the past initiatives were often poorly communicated and even more poorly understood, salespeople and consumers were often not able to take advantage of these synergies. The initiative analyzer vitiates this problem by providing salespeople with information regarding the ability to and effect of combining initiatives. For example, the total savings available to a customer may be presented. Likewise, the total financial incentive for the salesperson may be determined and provided for the salesperson to view, e.g., as an incentive to sell the combined product and/or service offering. The initiative analyzer then is a computational module that allows for scenario planning by computing the benefits of (as well as the requirements for) combining initiatives.

FIG. 1B is a block diagram depicting exemplary sets of data or databases that may be included in initiative data 110. For example, initiative data 110 may include one or more of product, service, policy, and/or goal data 150, customer, prospect, and/or target profiles 155, geographic and/or geologic data 160, and/or previously designed initiative data 165. Product, service, policy, and/or goal data 150 may include information related to an initiative and/or one or more products, services, policies, and/or goals included in and/or related to an initiative. For example, product, service, policy, and/or goal data 150 may include demographics, goals, names, descriptions, specifications, purchasing patterns, profit margins, and/or inventory data relating to one or more products and/or initiatives. Product, service, policy, and/or goal data 150 may also include information specific to one or more initiatives, such as, incentives offered for executing an initiative, a date range for executing an initiative, a game plan related to an initiative, and potential targets or customers for an initiative.

Customer, prospect, and/or target profiles 155 may include information, or profiles, associated with, for example, one or more initiatives, targets of an initiative, and/or users, such as user 125 and/or initiative-designing user 105. For example, customer, prospect, and/or target profiles 155 may include the names, locations, purchasing patterns, social contacts, business contacts, a degree of influence a contact may have on a user/customer, and/or business organization for one or more customers.

Previously designed initiative data 165 may include information associated with one or more previously designed and/or distributed initiatives. For example, previously designed initiative data 165 may include information related one or more incentives offered for executing an initiative, a date range for an initiative, a participation rate for an initiative, sales of a product related to an initiative, profits related to an initiative, a game plan related to an initiative, and potential targets for the initiative.

Geographic and/or geologic data 160 may include geographic and/or geologic data related to, for example, an initiative, a target of an initiative, a customer, and/or a user, such as user 125 and/or initiative-designing user 105. Geographic and/or geologic data 160 may be derived from a variety of sources, such as satellite images, global positioning information, historical information regarding an area of land, information provided by a customer and/or user, such as user 125 and/or initiative-designing user 105.

On some occasions, the geographic and/or geologic data 160 may be part of a GIS, an example of which is provided in FIG. 1C. As shown, a GIS includes various data structures, each of which may be regarded as a layer. Different layers provide information regarding various aspects of a region, for example, topographic information, (e.g., slope elevation, availability of water), geological information, boundaries and/or statistics (e.g., size, location, etc.), soil types, texture, organic matter, fertility, how the land and/or fields are operated upon, any man-made features upon the land (e.g., buildings, roads, ditches), social relationships associated with an owner and/or operator of the land (e.g., information regarding relationships with neighbors and others operating in a similar or different types of business than the land-owner or a degree of influence a contact may exert on an owner and/or operator of the land), weather patterns associated with the land (e.g., climate information, rainfall, average temperatures, etc.), logistical information (e.g., key operational locations for a user of the land, such as locations for the storage of goods, suppliers, customers, etc.), a usage history for the land (e.g., prior products used, prior products grown, etc.), a history of practices used on the land (e.g., planting and/or harvesting schedules), crops that are currently planted, and current crop conditions, etc.

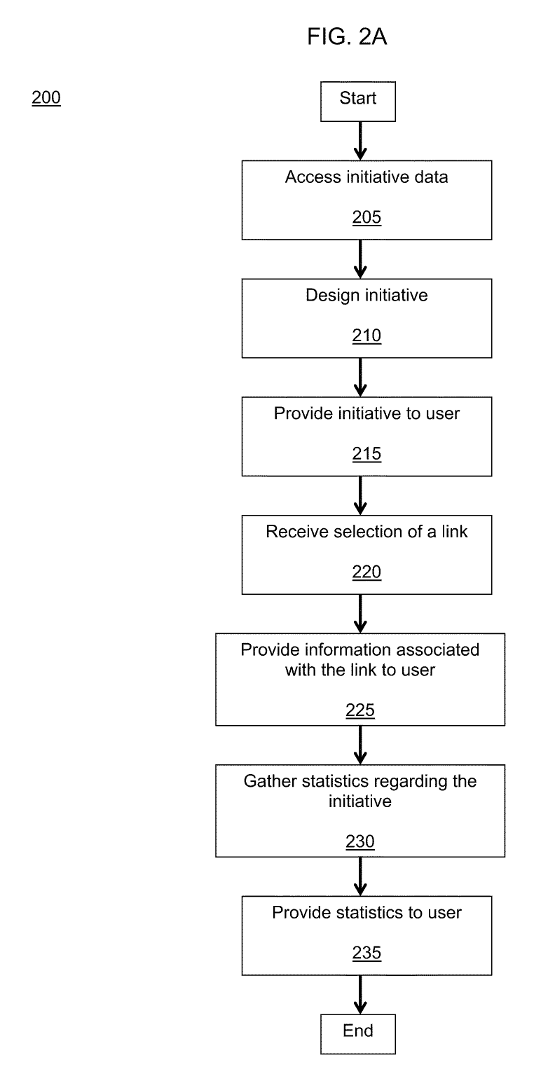

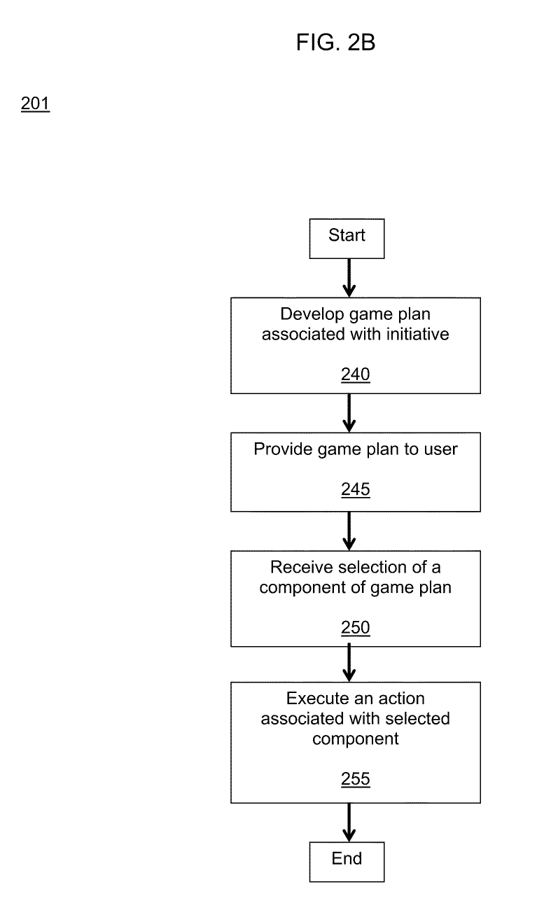

FIG. 2A is a flow chart depicting an exemplary process 200 for providing an initiative to a user, such as user 125. Process 200 may be executed by, for example, any of the systems and/or system components disclosed herein. The initiative may relate to, for example, the selling of a product or a service to a target and/or customer or an incentive for the user to sell a product or a service to a target and/or customer.

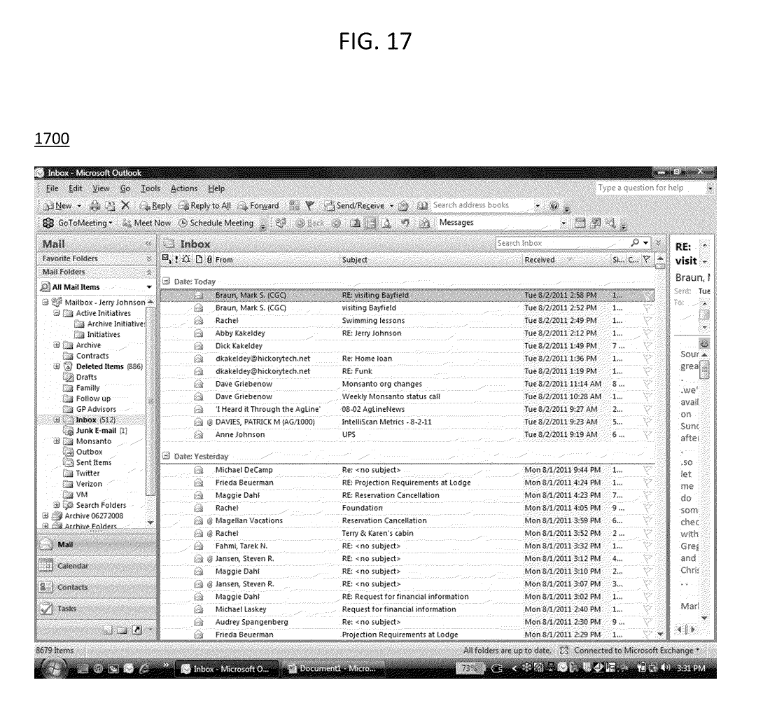

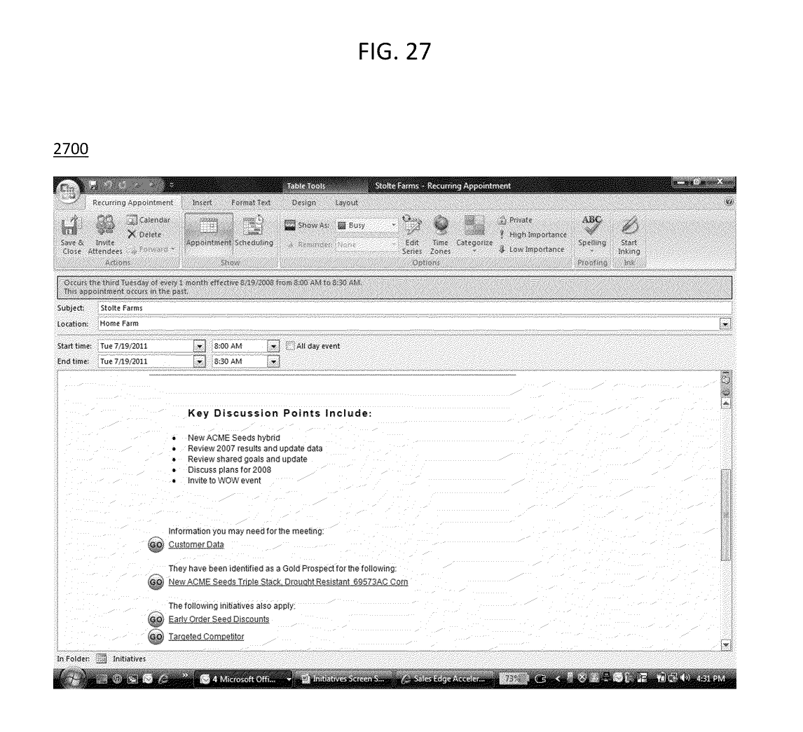

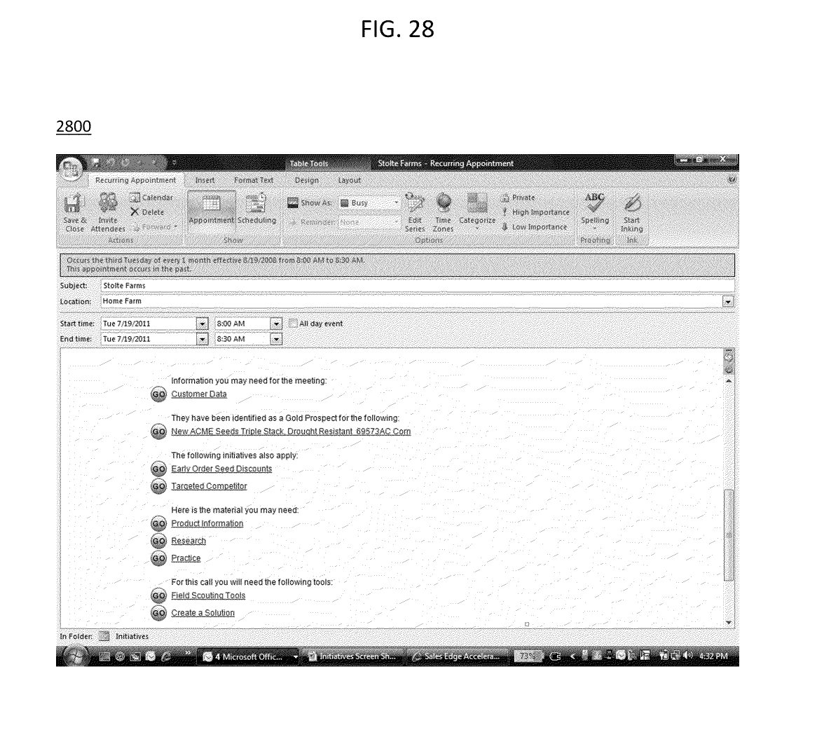

In step 205, initiative data stored in, for example, initiative data 110 and/or user data 130 may be accessed by an initiative designer, such as initiative designer 115 and used to design an initiative (step 210). The initiative so designed may then be provided to a user (step 215), such as user 125 and/or initiative-designing user 105 via a communication network, such as communication network 145, via a display device, such as display device 120. Information concerning the initiative may be provided to the user via, for example, an e-mail, an alert, a message, a SMS text message, and/or a phone call. The user may then access the initiative via a GUI, such as GUIs 1700-3100 as discussed below with regard to FIGS. 17-31. In some embodiments, multiple users may be enabled to communicate with one another via the communication network in a manner similar to, for example, a social network and/or social networking information (e.g., a relative strength of a social connection) may be used to design the initiative.

In some embodiments, the information regarding the initiative may include directions or a hyperlink to supplemental information regarding the initiative that is selectable by a user and, in step 220, selection of such a hyperlink may be received. Supplemental information associated with the selected link may then be provided to the user via, for example, the display device and/or communication network (step 225). Exemplary supplemental initiative information includes details regarding the initiative, such as the financial terms of the initiative for the customer, collateral materials regarding an offer for the sale of a product or service, details regarding incentives for the selling of a product or service, a range of dates the initiative is available, a product or service description, a schedule for implementation of the initiative, and so on.

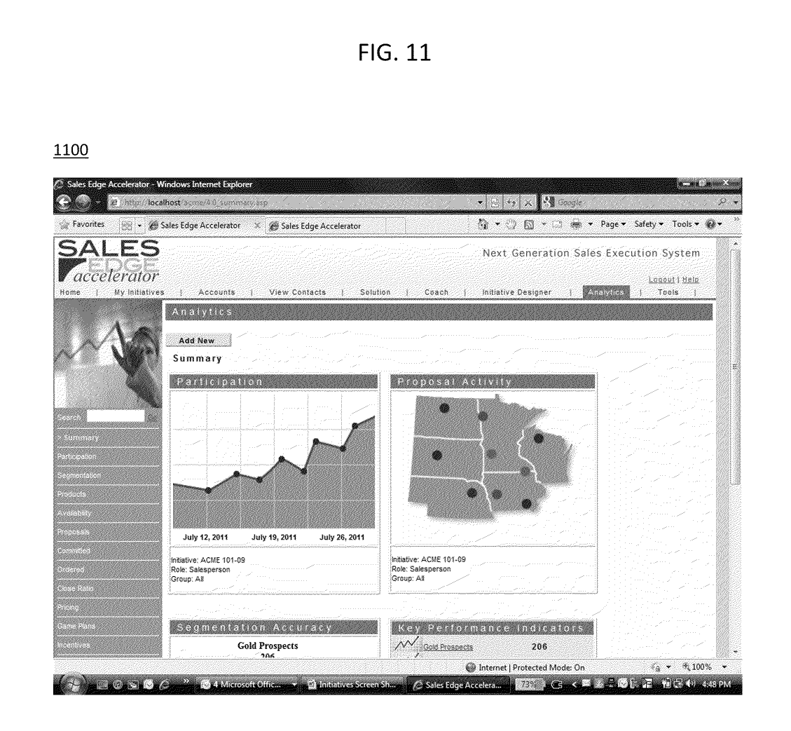

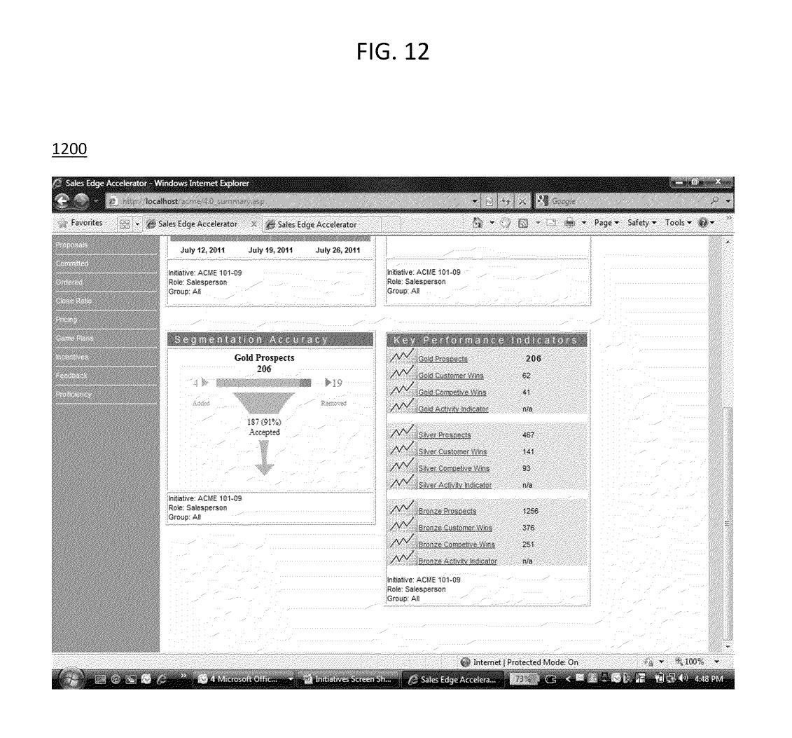

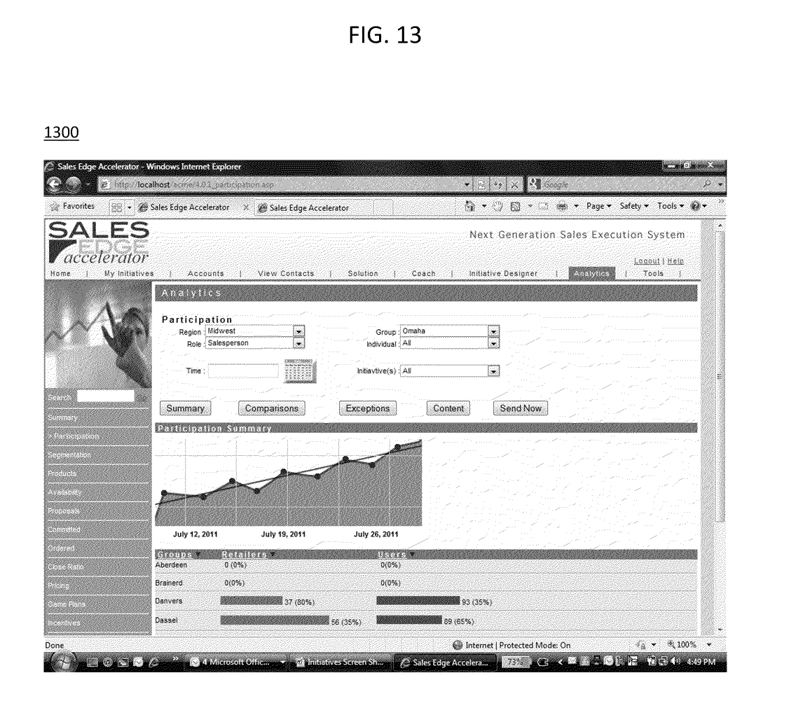

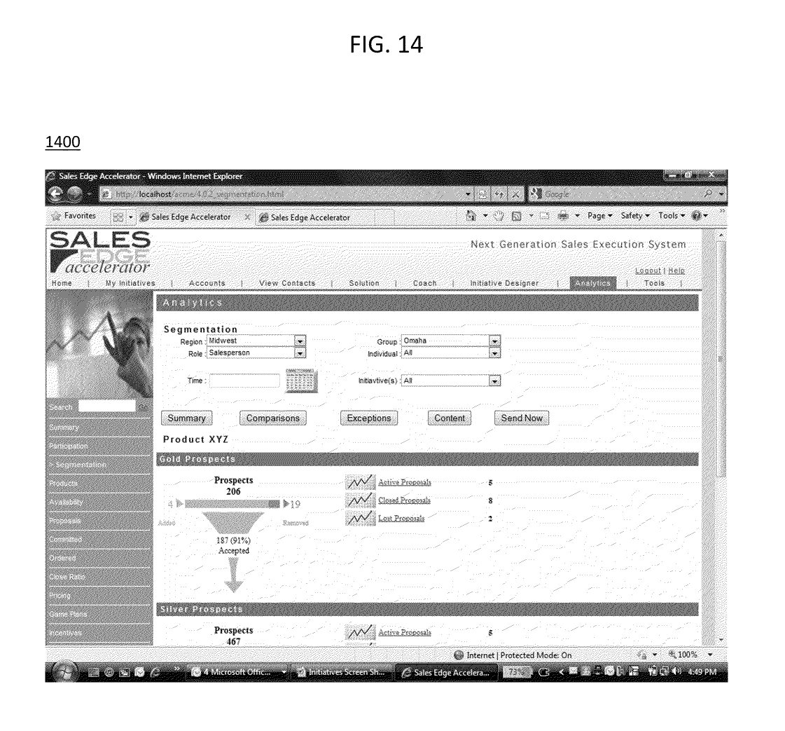

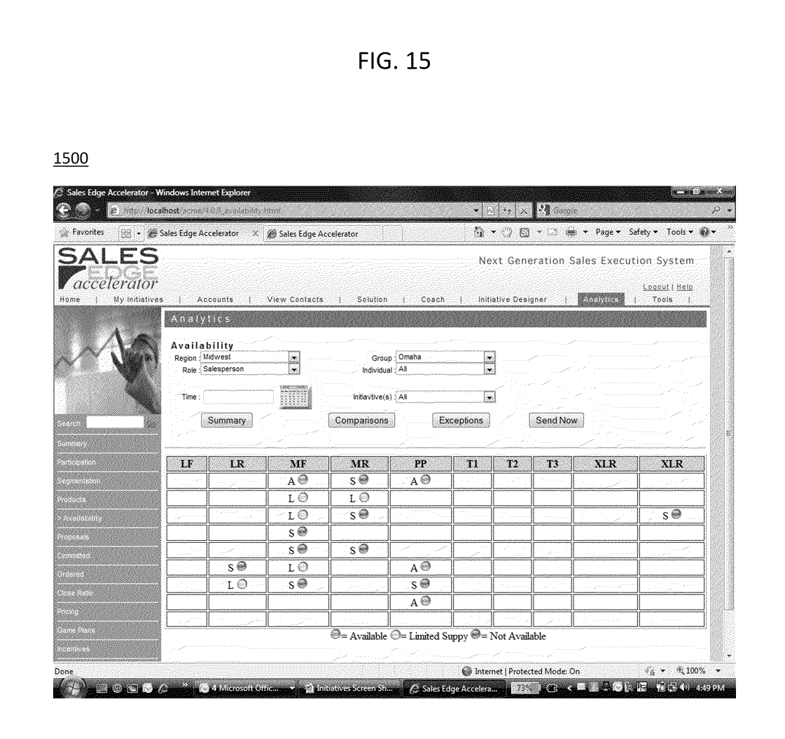

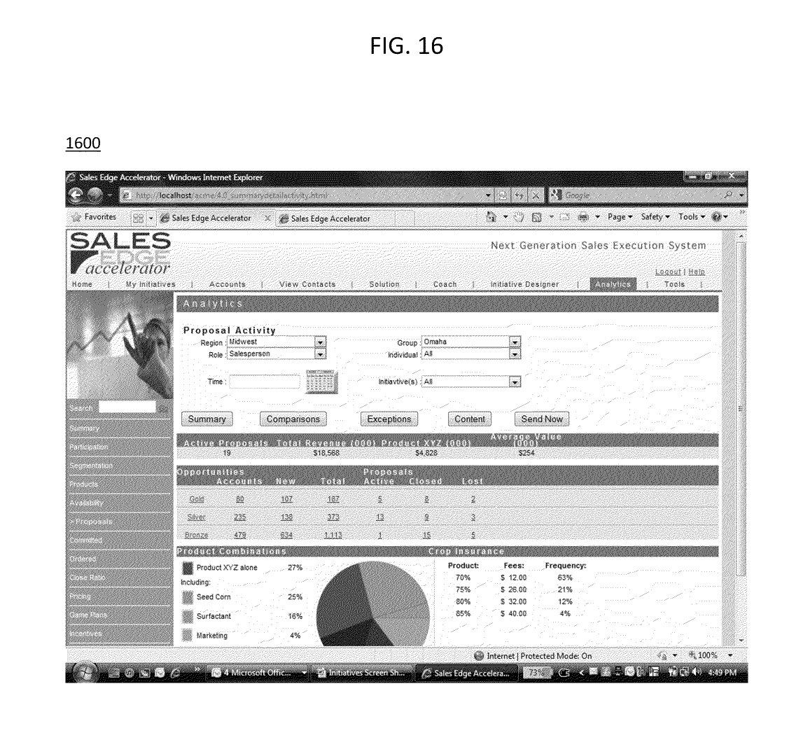

Optionally, in step 230, statistics regarding the initiative may be gathered and provided to, for example, the initiative-designing user (step 235). Exemplary statistics that may be gathered include a participation rate for the initiative, sales of a product related to the initiative, profits related to the initiative, a game plan related to the initiative, and potential targets for the initiative. In some embodiments, the type of statistics gathered and/or provided to the user may depend upon the type of user working with the initiative. For example, when the user is a salesperson, the statistics may reflect potential sales and/or profits related to the initiative, when the user is a customer, the statistics may relate to reasons to participate in the initiative or purchase a particular good or service related to the initiative, when the user is an initiative designer, governmental employee, or member of an organization, the statistics may relate to participation in the initiative and/or a status for users and/or recipients of an initiative. On some occasions, the gathered statistics may be provided to the user via one or more summary pages and/or summary GUI, such as GUI 1100-1600 as discussed below with regard to FIGS. 11-16.

FIG. 2B is a flow chart depicting an exemplary process 201 for developing and executing a game plan associated with an initiative. Process 201 may be executed by, for example, any of the systems and/or system components disclosed herein.

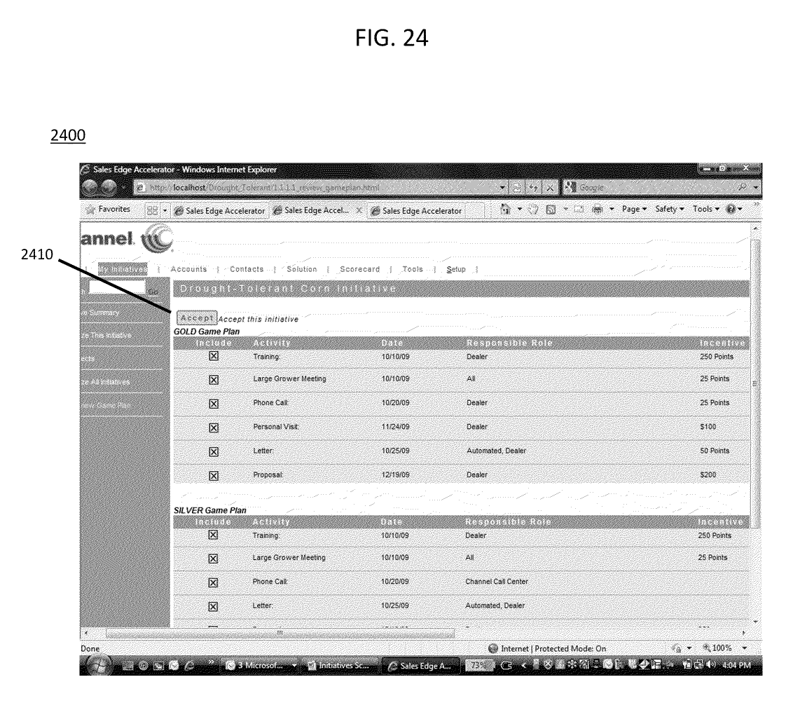

In step 240, a game plan may be developed by, for example, an initiative designer, such as initiative designer 115 using, for example, initiative data extracted from, for example, initiative data 110, and input from an initiative-designing user, such as initiative-designing user 105. A game plan may include various events and/or actions for a user to execute in order to facilitate execution of the initiative. Further details regarding game plans are discussed below with regard to GUIs 2400-2800 as discussed below with regard to FIGS. 24-28.

In step 245, the game plan may be provided to a user, such as user 125 and/or initiative-designing user 105 via a communication network, such as communication network 145 via a display device, such as display device 120. The game plan may be provided to the user via, for example, an e-mail, an alert, a message, a SMS text message, and/or a phone call.

A selection of a component of a game plan may then be received (step 250) and an action associated with the selected component may be executed (step 255). For example, a user may select a game plan calendar link and his or her calendar may then be populated with an appointment associated with the selected link.

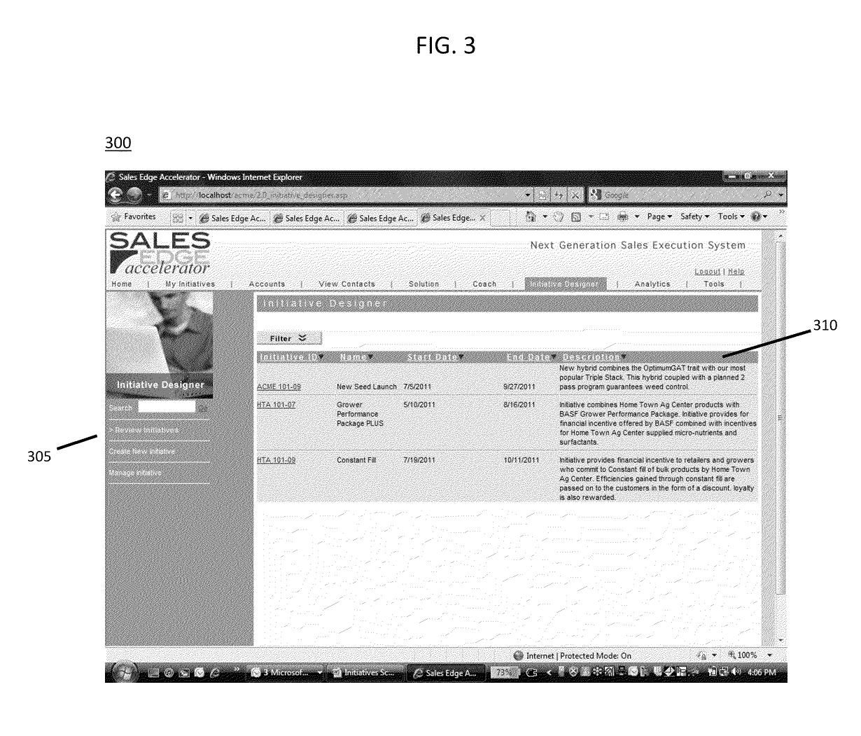

FIGS. 3-16 are representative screen shots depicting exemplary GUIs to assist a user of an initiative designer, such as initiative-designing user 105 when entering data to be used to design and generate an initiative. Although the GUIs of FIGS. 3-16 are shown in sequential order, they may be provided to and/or used by the initiative-designing user in any order and, of course, complete information does not need to be entered into every GUI provided in FIGS. 3-16 for an initiative to be designed.

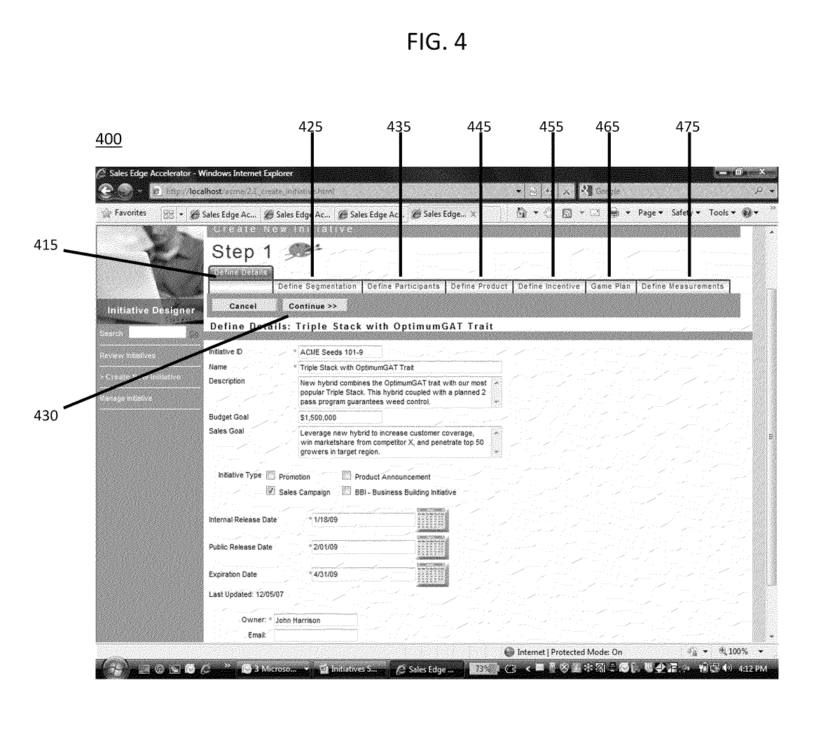

The screen shot of FIG. 3 depicts an exemplary GUI 300 for generating and/or managing an initiative. GUI 300 may include a list of previously designed initiatives 310 that may provide, for example, a name and other details (e.g., a description or date range for the initiative) regarding the previously designed initiatives. GUI 300 may also include a menu of options 305 including a create new initiative selectable option which, when selected, may cause a create new initiative GUI, such as the new initiative GUI 400, to be displayed as depicted in FIG. 4. GUI 400 may include a menu of tabs that link to other GUIs configured to enable an initiative-designing user to design an initiative. For example, the menu of tabs may include a define details tab 415, a define segmentation tab 425, a define participants tab 435, a define product tab 445, a define incentive tab 455, a game plan tab 465, and a define measurements tab 475.

GUI 400 may enable an initiative-designing user to enter data and select various options for inclusion in a new initiative and/or modify an existing initiative. For example, GUI 400 may include text boxes in which the initiative-designing user is enabled to enter information regarding a new initiative (e.g., an ID, a name, a description, a budget goal, and/or a sales goal regarding the initiatives). GUI 400 may also include check boxes by which the initiative-designing user may select a variety of options to be associated with the new initiative. GUI 400 may further include a calendar by which the initiative-designing user may set a date or date range to be associated with the initiative.

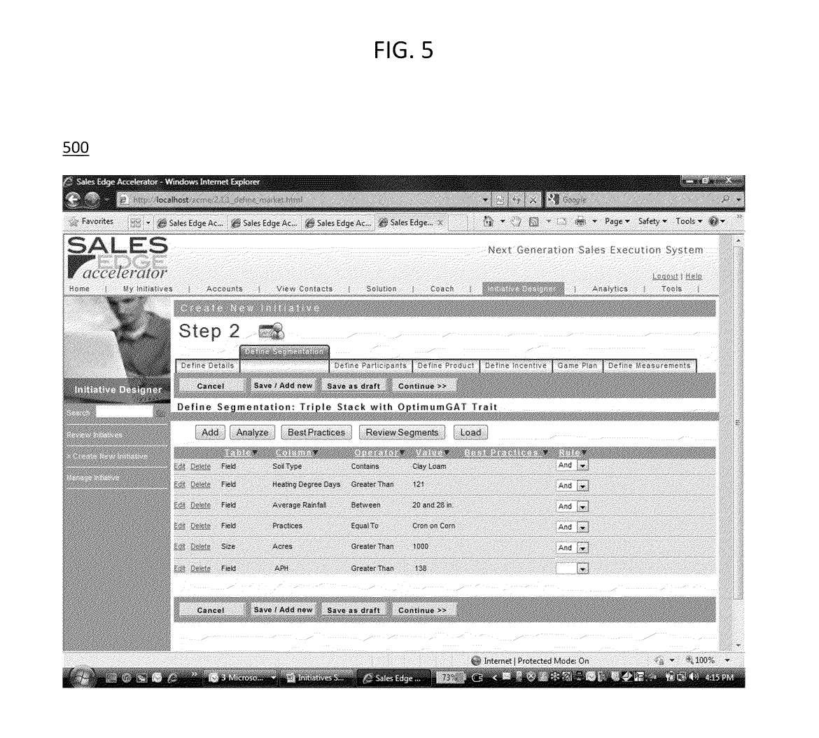

Selection of continue button 430 and/or define segmentation tab 425 may cause display of a define segmentation GUI, such as the define segmentation GUI 500 depicted in FIG. 5. The initiative-designing user may enter one or more segments or categories of information that may apply, or be relevant to, an initiative.

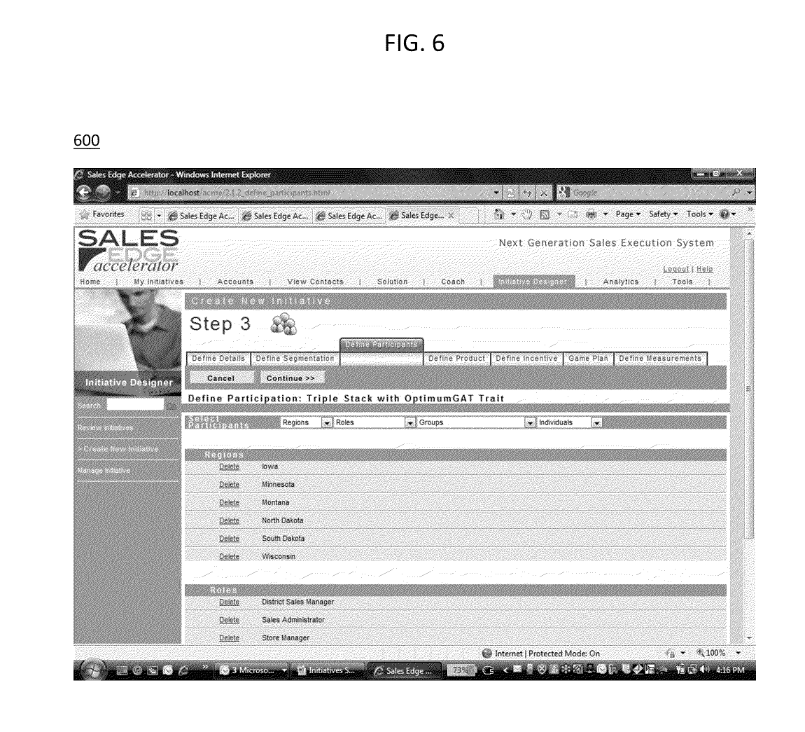

Selection of continue button 430 and/or define participants tab 435 may cause display of a define participants GUI, such as the define participants GUI 600 depicted in FIG. 6. The initiative-designing user may define one or more participants for an initiative via entering data into GUI 600. For example, GUI 600 may include one or more drop-down lists that enable the initiative-designing user to select various categories (e.g., regions, roles, groups, and/or individual names) of users, participants, and/or customers to be associated with an initiative. GUI 600 may also include one or more lists of participants. Participants included in the list of participants may be available for selection from, for example, a database, a known list of participants, the initiative-designing user's contact list, and/or a contact list associated with a social networking service.

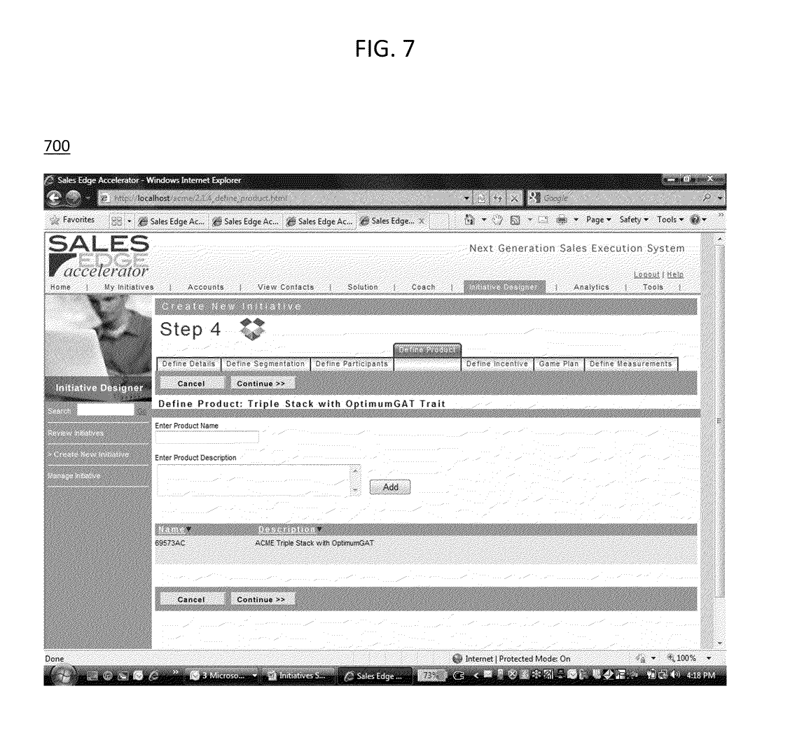

Selection of continue button 430 and/or define product tab 445 may cause display of a define product GUI, such as the define product GUI 700 depicted in FIG. 7. The initiative-designing user may define one or more products for inclusion in an initiative via entering data into GUI 700. For example, GUI 700 may include one or more text entry boxes via which the initiative-designing user may enter data regarding a product to be included in the initiative. GUI 700 may also include a list of defined products.

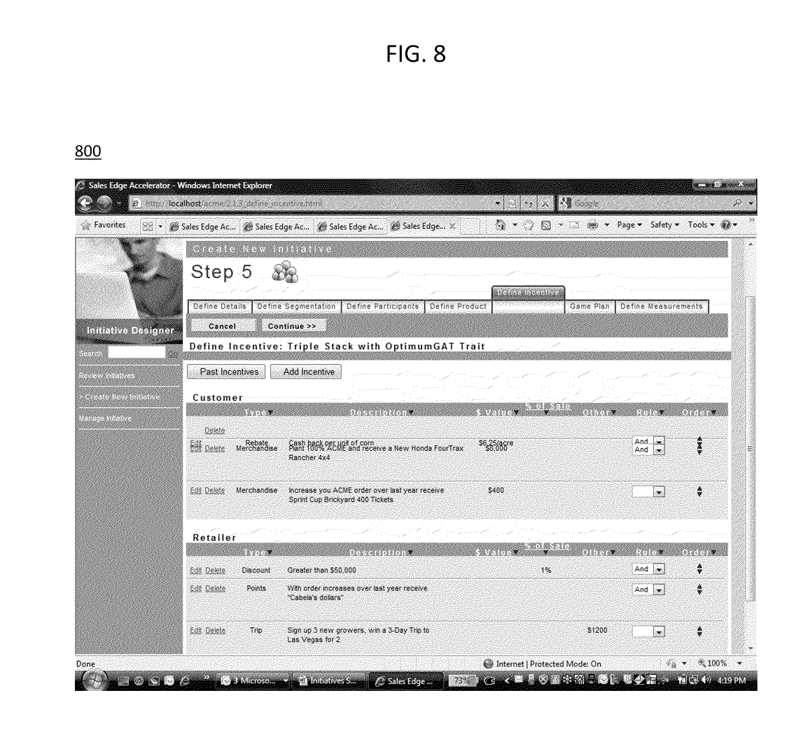

Selection of continue button 430 and/or define incentive tab 455 may cause display of a define incentive GUI, such as the define incentive GUI 800 depicted in FIG. 8. The initiative-designing user may define one or more incentives for inclusion in an initiative via entering data into GUI 800. For example, GUI 800 may include a list of one or more incentives for a customer of a product or service associated with the incentive (in this case an incentive for “triple stack with optimumGAT trait”) and a list of one or more incentives for a retailer of a product or service associated with the incentive. Lists provided by GUI 800 may also include one or more attributes of an incentive included therein.

Selection of continue button 430 and/or game plan tab 465 may cause display of a game plan GUI, such as the game plan GUI 900 depicted in FIG. 9. A game plan may be a series of one or more events or action items for a user or participant in the initiative to perform in order to meet an objective of the incentive. In some cases, there may be more than one game plan associated with the initiative. For example, when the initiative relates to selling triple stack with optimum GAT trait, GUI 900 may provide one or more game plans designed to assist the participant and/or user in the sale of products or services associated with the initiative. In some cases, the initiative-designing user may be an organization or multiple individuals and the game plan may include events or action items for each of the multiple individuals and/or members of the organization.

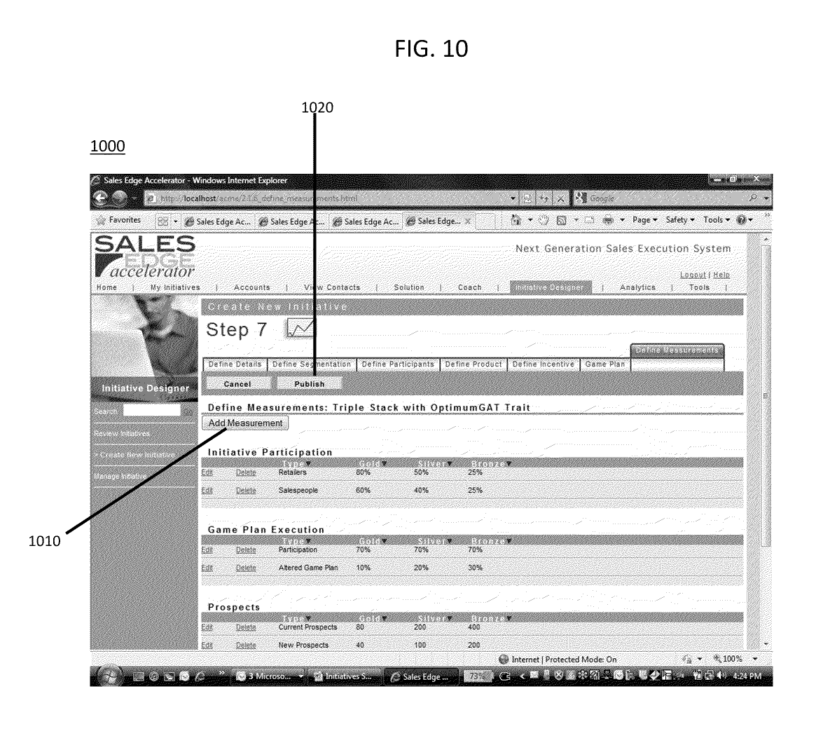

Selection of continue button 430 and/or define measurements tab 475 may cause display of one or more measurements relating to the initiative on a measurements summary GUI, such as measurements summary GUI 1000 as depicted in FIG. 10. By selecting an add measurement button 1010, an initiative-designing user may add one or more ways the progress of the initiative may be measured. For example, a initiative-designing user may add a measurement to track participation in the initiative, participation in a game plan, prospective participation in the game plan, proposal activity related to the initiative, segmentation accuracy, key performance indicators, inventory associated with the initiative, deliveries associated with the initiative, sales associated with the initiative, profits associated with the initiative, customer information, salesperson information, retailer information, etc. The results of the measurements may be displayed and/or manipulated in any fashion, examples of which are provided in GUI 1000 and summary GUI 1100-1600 as depicted in FIGS. 11-16, respectively.

An initiative-designing user may then publish the initiative by, for example, selecting publish button 1020. Following selection of publish button 1020, the initiative may be published, or made available to, one or more users, such as user 125. Examples of published initiatives are shown in GUI 1700-2900 as depicted in FIGS. 17-29, respectively.

An initiative may be published to a user via, for example, an email, an alert, a message, a SMS text message, a message relayed via a messaging system associated with a social networking application, and a phone call. FIG. 17 shows a representative screen shot of an email GUI 1700 including a list of a user's email messages 1710, wherein at least one of the email messages displayed in the list includes a published initiative.

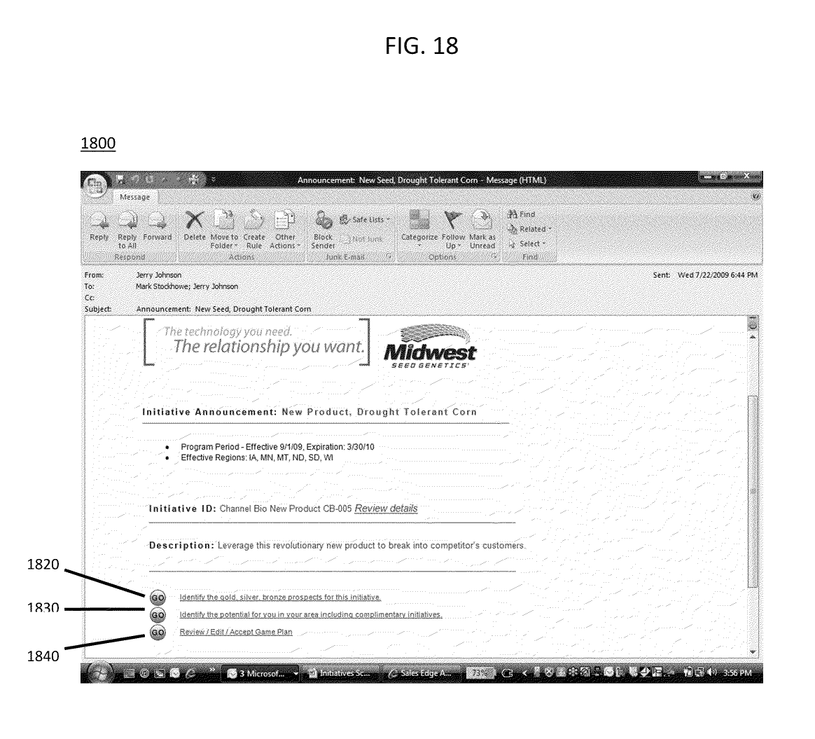

FIG. 18 shows an exemplary published initiative GUI 1800 emailed to the user. Published initiative GUI 1800 may include information associated with the initiative, such as, but not limited to, a title of the initiative, a range of effective dates for the initiative, a description of the initiative, and incentive for participating in the initiative, and one or more links to supplemental initiative information. Exemplary links include a link to prospects or potential customers for the initiative (known as “targets” for the initiative) 1820, a link to comparative initiative analysis 1830, and a link to a game plan 1840. Exemplary targets for an initiative include potential customers, previous customers, and salespeople. In the example provided in FIGS. 18-31, targets for the initiative are corn farmers.

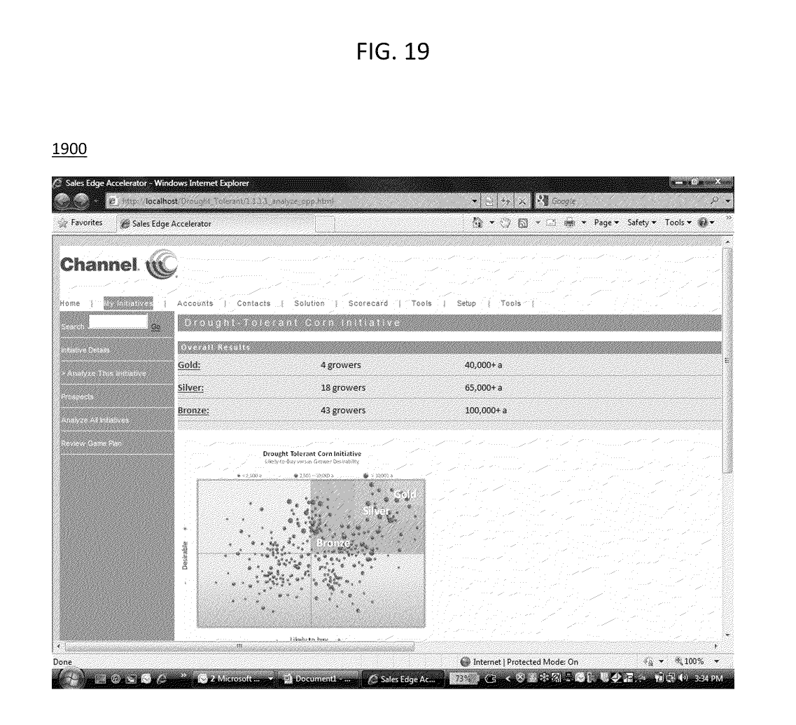

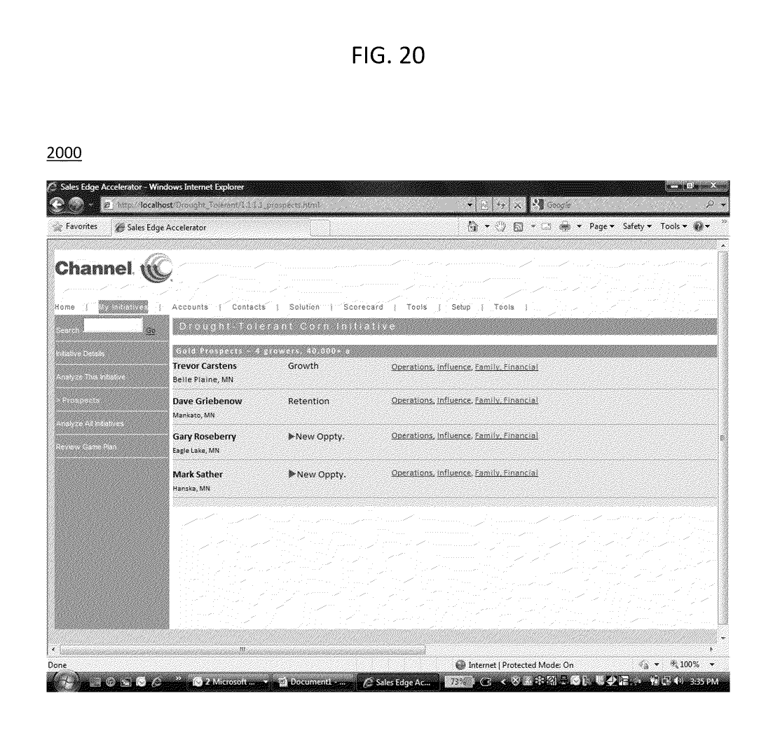

Selection of an identify prospects or potential customers for the initiative link 1720 may cause display of a GUI 1900 providing information regarding prospects or potential customers for the initiative as shown in FIG. 19. For example, GUI 1900 shows how many growers/customers participate in initiative for selling drought tolerant corn, where growers/customers are classified as “gold,” “silver,” and “bronze.” Selection of a link associated with the growers classified as “gold” may cause display of a GUI 2000 that provides detailed information regarding the four growers classified as “gold” as depicted in FIG. 20. In some cases, GUI 2000 may include links to further information regarding a grower/customer depicted on GUI 2000. For example, GUI 2000 may include links regarding the operations, influence, family, and/or financial information associated with a particular target of the initiative and in some cases may include links to social or professional relationships associated with a particular target of the initiative.

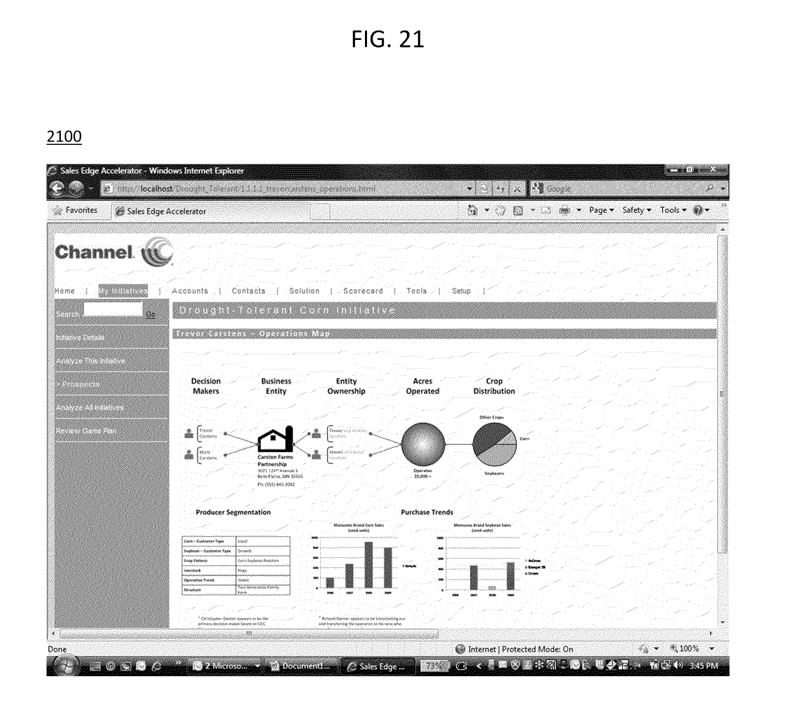

Selection of the operations link may cause display of an operations GUI, such as the operations GUI 2100 shown in FIG. 21 and may provide information regarding the business operations of a target of the initiative (in this case, Trevor Carstens). For example, operations GUI 2100 may include information regarding the organization of the target's business (e.g., decision-makers, type of business entity, and entity ownership), assets owned by the target, purchasing trends and/or producer segmentation information (e.g., what the target produces).

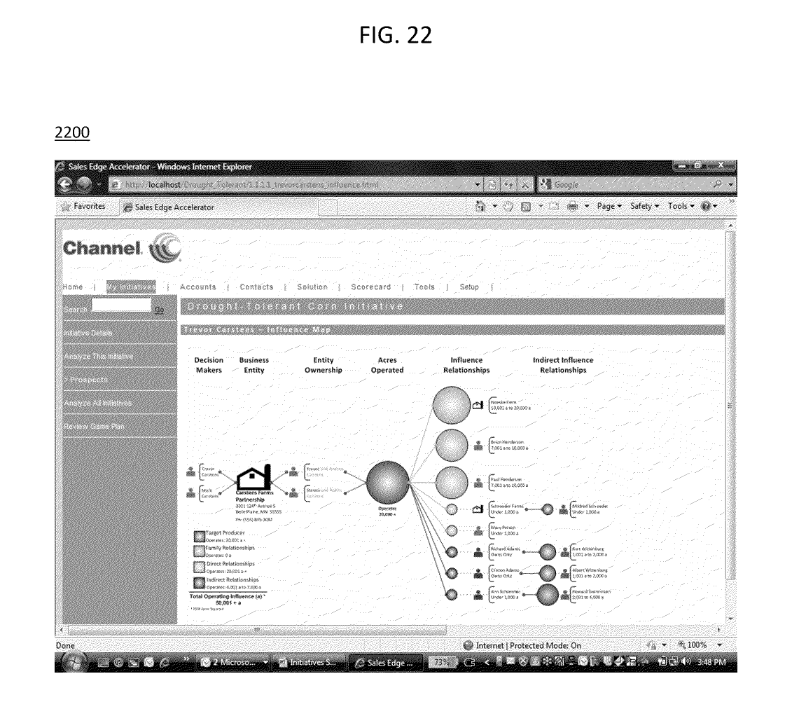

Selection of influences link may cause display of an influences GUI, such as the influences GUI 2200 shown in FIG. 22 and may provide information regarding various influences that may affect the business operations of a target of the initiative (in this case, Trevor Carstens). For example, influences GUI 2200 may include information regarding direct and/or indirect influence relationships between the target of the initiative and one or more additional entities and/or individuals. On some occasions, the relative strength of the influence/relationship may also be depicted in GUI 2200.

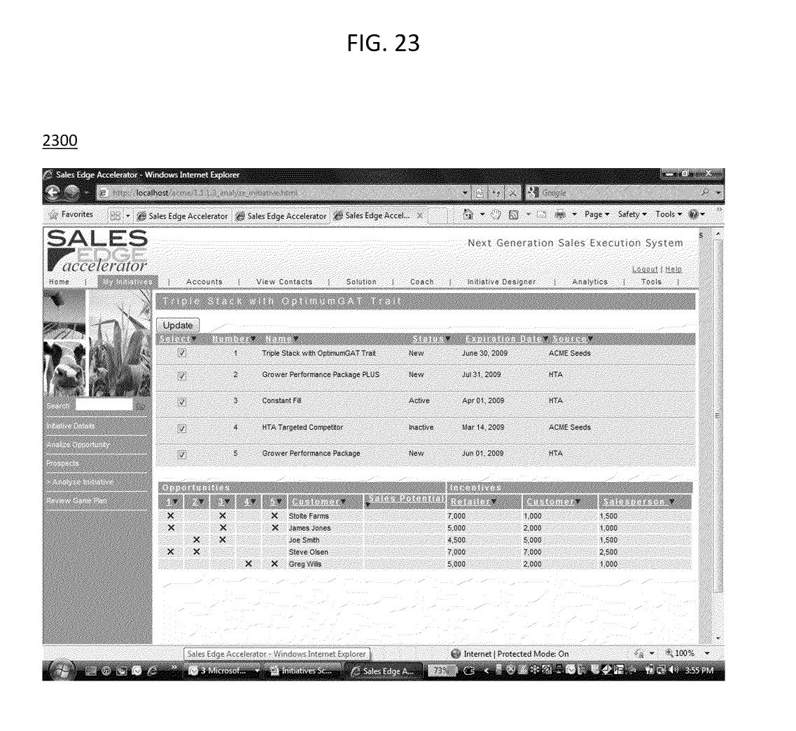

Selection of an initiative comparison link (labeled as “identify the potential for you in your area including complementary initiatives” in FIG. 18) may cause display of an initiative comparison GUI 2300 providing information regarding various initiatives the user may have access to as shown in FIG. 23. For example, initiative comparison GUI 2300 may include a list of initiatives and one or more tables comparatively listing various aspects of initiatives.

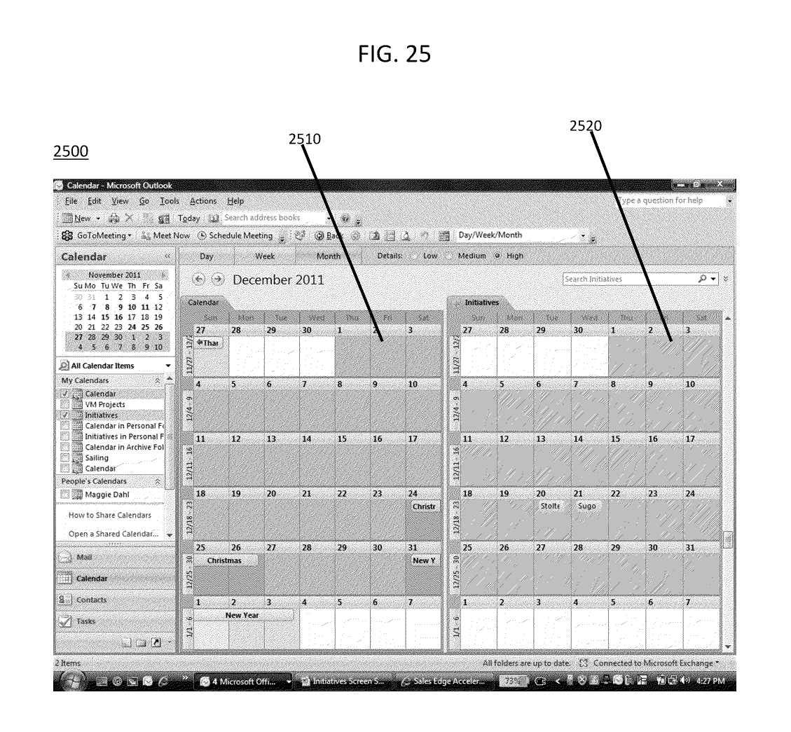

Selection of a game plan link 1740 may cause display of a game plan comparison GUI 2400 providing information regarding various game plans associated with the initiative as shown in FIG. 24. For example, GUI 2400 may include various activities, dates, responsiveness rates, and incentives associated with a particular game plan. GUI 2400 may also include selectable buttons or check boxes by which a user may opt into participating in a particular event or action item. GUI 2400 may further include an accept button 2410. Selection of accept button 2410 may initiate action in accordance with one or more selected portions of a game plan. For example, selection of accept button 2410 may populate a users calendar with appointments and reminders associated with a game plan as depicted in GUI 2500 as shown in FIG. 25. GUI 2500 may also provide a comparison of a user's existing calendar 2510 with a calendar of like dates and events and/or action items related to the game plan 2520.

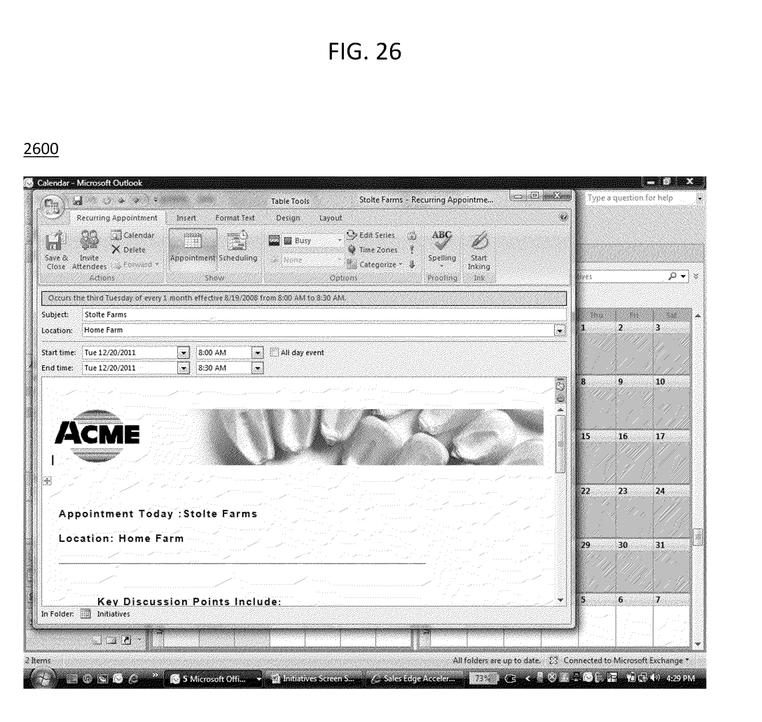

On some occasions, the events and/or action items provided on the event and/or action item calendar 2520 may be selectable by the user. On these occasions, selection of an event and/or action item (in this case, “Stolte Farms” on Dec. 20, 2011) may cause an event GUI, such as event GUIs 2600-2800, to be displayed as depicted in FIGS. 26-28, respectively. In the example provided, event GUIs 2600-2800 are a series of screen shots for a single event regarding an appointment with Stolte Farms to discuss new hybrid seeds, review results for the 2007 growing season, review and update shared goals, discuss plans for an upcoming year, and provide an invitation to a future event. Event GUIs 2600-2800 may include, for example, information regarding an event, such as a name and description of the event, a date range for the event, key discussion points for the event, a goal for the event, and one or more links via which the user may access other initiatives, and/or enter information regarding, for example, the event and/or initiative.

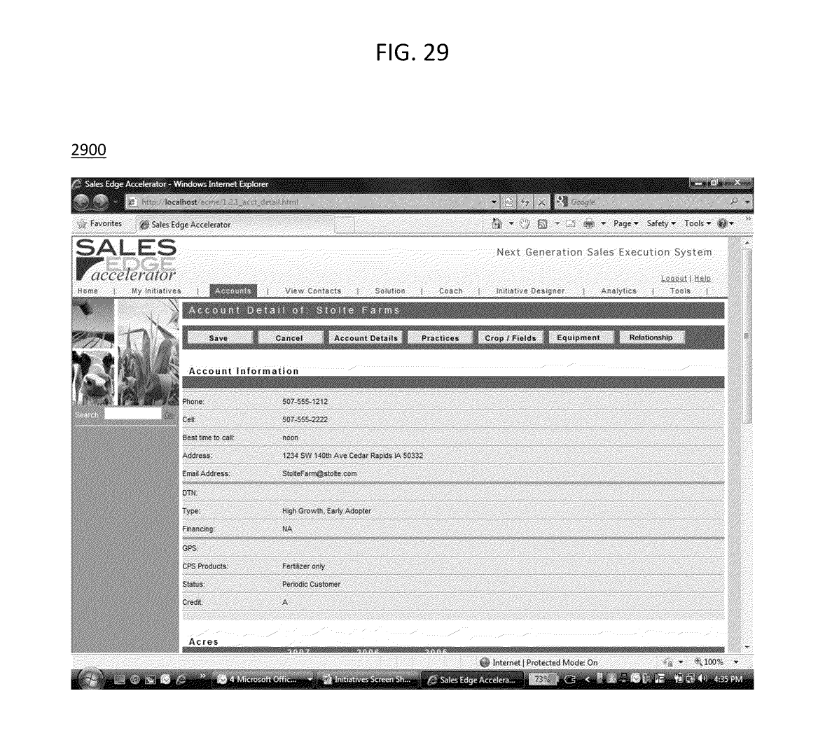

FIG. 29 provides an exemplary account information GUI 2900 that provides information regarding an account associated with the user. For example, account information GUI 2900 may provide information identifying an account and a purchase history for the account.

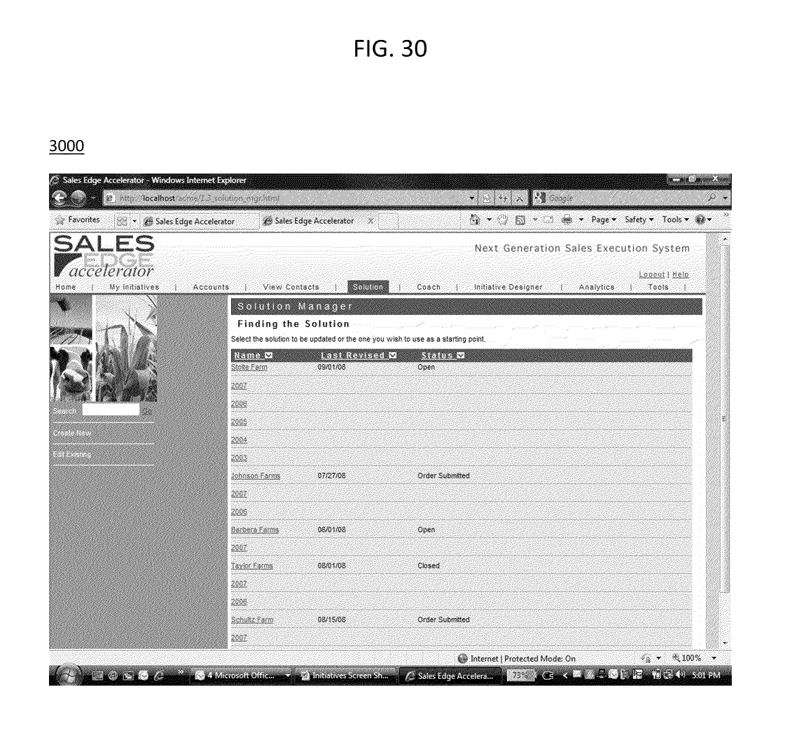

FIG. 30 provides an exemplary solution manager GUI 3000 that provides information regarding solutions to problems or situations the user and/or an account or customer associated with the user and/or initiative may have. For example, solution manager GUI 3000 may provide a list of solutions that may be selected by the user.

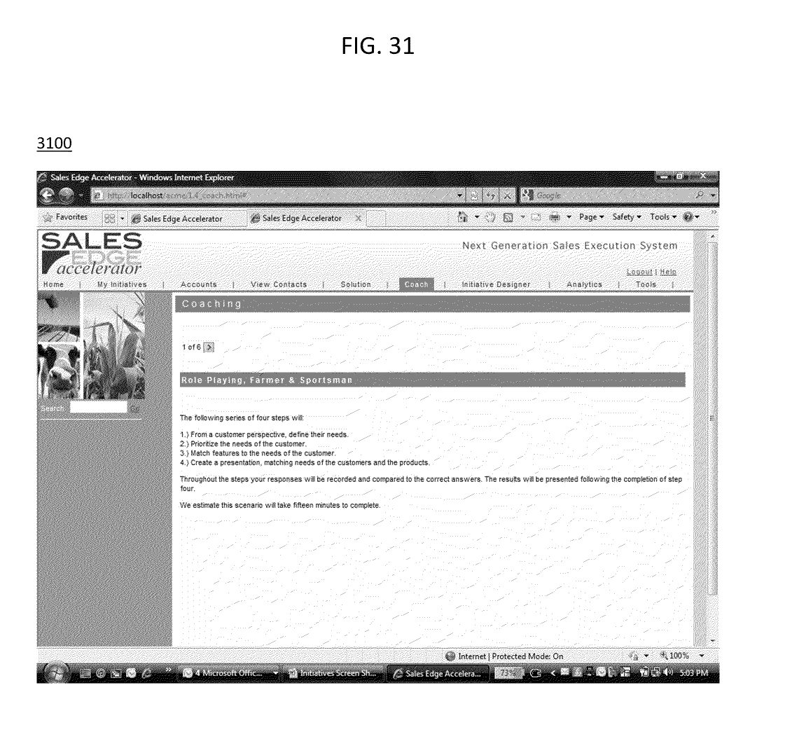

FIG. 31 provides an exemplary coaching GUI 3100 that provides coaching or suggestions for the execution of initiatives and/or game plans.

Thus, systems, graphic user interfaces, and methods for designing an initiative have been herein described.

What is claimed is:

1. A method comprising:
accessing, by an initiative designer, initiative data stored in one or more databases and designing an initiative therefrom, the initiative comprising a link to supplemental information regarding the initiative selectable by a user via a user interface communicatively coupled to the initiative designer via a communication network;
providing, by the initiative designer, the initiative to the user interface via the communication network;
receiving, by the initiative designer, a selection of the link from the user interface via the communication network; and
providing, by the initiative designer, the supplemental initiative information to the user interface via the communication network.

2. The method of claim 1, wherein the initiative data relates to at least one of initiative specifications, customer profiles, specifications of previously designed initiatives, product information, service information, pricing information, incentives, inventory information, geographic information, geologic information, data regarding an entity associated with the user, a policy, and a goal.

3. The method of claim 1, wherein the initiative data relates to geographical data and includes information regarding various aspects of an area of land, each aspect being represented by a layer, the geographical data including an overlay of multiple layers.

4. The method of claim 1, further comprising:
accessing, by the initiative designer, a database operated by the user and extracting data therefrom; and
using, by the initiative designer, the extracted data to design the initiative.

5. The method of claim 1, wherein the initiative relates to the selling of a product or a service by the user to a customer.

6. The method of claim 1, wherein the communication network is at least one of a cloud computing network, the Internet, a local area network (LAN), a wireless local area network (WLAN), and a wide area network (WAN).

7. The method of claim 1, wherein the initiative is provided to the user via at least one of an email, an alert, a message, an instant message, a short message service (SMS) text message, a message relayed via a messaging system associated with a social networking application, and a phone call.

8. The method of claim 1, wherein the supplemental initiative information is at least one of an offer for the sale of a product or service, an incentive for the selling of a product or service to a customer, a commission for the sale of a product or service, a range of dates the initiative is available, a product or service description, a schedule for implementation of the initiative, a rebate offer, a loan offer, a discount, and a profit from the sale of a product or service.

9. The method of claim 1, further comprising:
enabling, by the initiative designer, multiple users of the initiative designer to communicate with one another via the communication network.

10. The method of claim 1, further comprising:
designing a game plan for implementation of the initiative and including a link to the game plan in the initiative.

11. The method of claim 1, further comprising:
gathering, by the initiative designer, statistics regarding the initiative; and
providing, by the initiative designer, the gathered statistics to the user.

12. A system comprising:
a database configured to store initiative data;
an initiative designer communicatively coupled to the database and configured to access the initiative data and design an initiative therefrom, the initiative comprising a link to supplemental information regarding the initiative selectable by a user via a user interface and provide the initiative to the user interface via a communication network;
the user interface configured to receive the initiative from the initiative designer via a communication network, provide the initiative to the user, receive a selection of the link from the user, communicate selection of the link to the initiative designer, receive the supplemental information from initiative designer via the communication network, and provide the supplemental information to the user; and
the communication network configured to enable communication between the initiative designer and the user interface.

13. The system of claim 12, further comprising:
an initiative analyzer communicatively coupled to the initiative designer configured to compare at least two initiatives and provide a comparison result to the user.

14. The system of claim 12, further comprising:
an initiative analyzer communicatively coupled to the initiative designer and configured to determine a benefit to the user resulting from implementation of the initiative.

15. The system of claim 12, further comprising:
a database operated by the user and communicatively coupled to the initiative designer, wherein the initiative designer is enabled to extract data therefrom and use the extracted data to prepare the initiative.

16. The system of claim 12, wherein the communication network is at least one of the Internet, a cloud computing network, a local area network (LAN), a wide area network (WAN), or a wireless LAN (WLAN).

17. A tangible, non-transitory computer-readable media including a set of instructions stored thereon which when executed by a computer enable the computer to access initiative data stored in one or more databases and design an initiative therefrom, the initiative comprising a link to supplemental information regarding the initiative selectable by a user via a user interface, provide the initiative to the user interface via a communication network, receive a selection of the link from the user interface via the communication network, and provide the supplemental initiative information to the user via the communication network.
